(19) United States
(12) Patent Application Publication
(10) Pub. No.: US 2022/0157508 A1
(43) Pub. Date: May 19, 2022

(54) FERRITE CORE

(71) Applicant: SUMITOMO WIRING SYSTEMS, LTD., Mie (JP)

(72) Inventor: Takashi NOBUKUNI, Mie (JP)

(21) Appl. No.: 17/522,532

(22) Filed: Nov. 9, 2021

(30) Foreign Application Priority Data
Nov. 18, 2020 (JP) 2020-191388

(51) Int. Cl. H01F 27/24; H01F 27/28

(52) U.S. Cl. CPC H01F 27/24; H01F 27/2823

(57) ABSTRACT

A ferrite core 10 includes a through hole 11 in which a wire 40 is arranged, and a holding portion 60 provided to hold the wire 40 in this through hole 11. The holding portion 60 may include a plurality of projections 61, 62 projecting from the inner peripheral surface of the through hole 11. Further, the plurality of projections 61, 62 are arranged at an interval in a length direction of the through hole 11 and at positions different in a circumferential direction of the through hole 11.

### CROSS-REFERENCE TO RELATED APPLICATIONS

This application is based on and claims priority from Japanese Patent Application No. 2020-191388, filed on Nov. 18, 2020, with the Japan Patent Office, the disclosure of which is incorporated herein in their entireties by reference.

### TECHNICAL FIELD

The present disclosure relates to a ferrite core.

### BACKGROUND

A wiring harness disclosed in Japanese Patent Laid-open Publication No. 2014-239145 includes a ferrite core. The ferrite core is formed into a ring shape. The ferrite core surrounds an inserted wire over an entire circumference. The ferrite core absorbs a magnetic field and converts the magnetic field into heat when a current flows in the wire, thereby reducing high-frequency noise radiated from the wire. Such a technique is also disclosed in Japanese Patent Laid-open Publication Nos. 2010-136485, 2015-011934 and 2015-233112.

### SUMMARY

In the case of Japanese Patent Laid-open Publication No. 2014-239145, positioning tapes are wound on the wire on both axial ends of the ferrite core to position the ferrite core with respect to the wire. In addition, a resilient tape is wound on the ferrite core and the positioning tapes and the entire assembly is further covered with a heat shrinkable tube. In this way, in the case of Japanese Patent Laid-open Publication No. 2014-239145, the ferrite core is positioned with respect to the wire on an outer peripheral side of the ferrite core. In contrast, if positioning can be performed utilizing an inner peripheral side of the ferrite core, it is preferable since options increase in selecting the ferrite core.

Accordingly, the present disclosure aims to provide a ferrite core having a novel positioning structure with respect to a wire.

The present disclosure is directed to a ferrite core with a through hole, a wire being arranged in the through hole, and a holding portion provided to hold the wire in the through hole.

According to the present disclosure, it is possible to provide a ferrite core having a novel positioning structure with respect to a wire.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side view in section showing a connector provided with a ferrite core according to an embodiment.

FIG. 2 is a perspective view showing a state where wires are inserted into the ferrite core according to the embodiment.

FIG. 3 is a plan view showing the ferrite core according to the embodiment.

FIG. 4 is a side view in section showing a state before the wire is inserted into the ferrite core according to the embodiment.

FIG. 5 is a side view in section showing a state during the insertion of the wire into the ferrite core according to the embodiment.

FIG. 6 is a side view in section showing a state where the insertion of the wire into the ferrite core according to the embodiment is completed.

FIG. 7 is a side view in section showing a ferrite core according to another embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, embodiments of the present disclosure are listed and described.

(1) The ferrite core of the present disclosure includes a through hole, a wire being arranged in the through hole, and a holding portion provided to hold the wire in the through hole. According to this configuration, a relative movement of the ferrite core with respect to the wire can be restricted and a novel positioning structure of the ferrite core with respect to the wire can be provided.

(2) Preferably, the holding portion includes a plurality of projections projecting from an inner peripheral surface of the through hole, and the plurality of projections are arranged at an interval in a length direction of the through hole and at positions different in a circumferential direction of the through hole. According to this configuration, the holding portion can be realized by a simple configuration.

(3) Preferably, the wire is such a coated wire that a core is surrounded around by a coating, and the core is exposed in a tip part, and a relational expression of b<a<c is satisfied when a denotes an opening diameter of a virtual circle defined by inner peripheral edges of the plurality of projections when the through hole is viewed from the length direction, b denotes an outer diameter of the core and c denotes an outer diameter of the coating. According to this configuration, in inserting the tip part of the wire into the through hole, the interference of the core exposed in the tip part of the wire with the projections can be avoided or mitigated. In the present disclosure, a proper holding force can act between the projections and the coating. As a result, the wire can be smoothly inserted and, moreover, the wire can be satisfactorily held by the projections.

(4) At least one of the plurality of projections may be provided in an opening of the through hole. According to this configuration, since a worker more easily visually confirms the projection, the wire can be easily inserted through the opening while avoiding the projection.

(5) The holding portion may be entirely provided in the through hole.

According to this configuration, the holding portion is less likely to interfere with external matters and the damage of the holding portion can be prevented.

### Details of Embodiments of Present Disclosure

A specific example of a ferrite core according to an embodiment of the present disclosure is described below with reference to the drawings. Note that the present invention is not limited to these illustrations and is intended to be represented by claims and include all changes in the scope of claims and in the meaning and scope of equivalents.

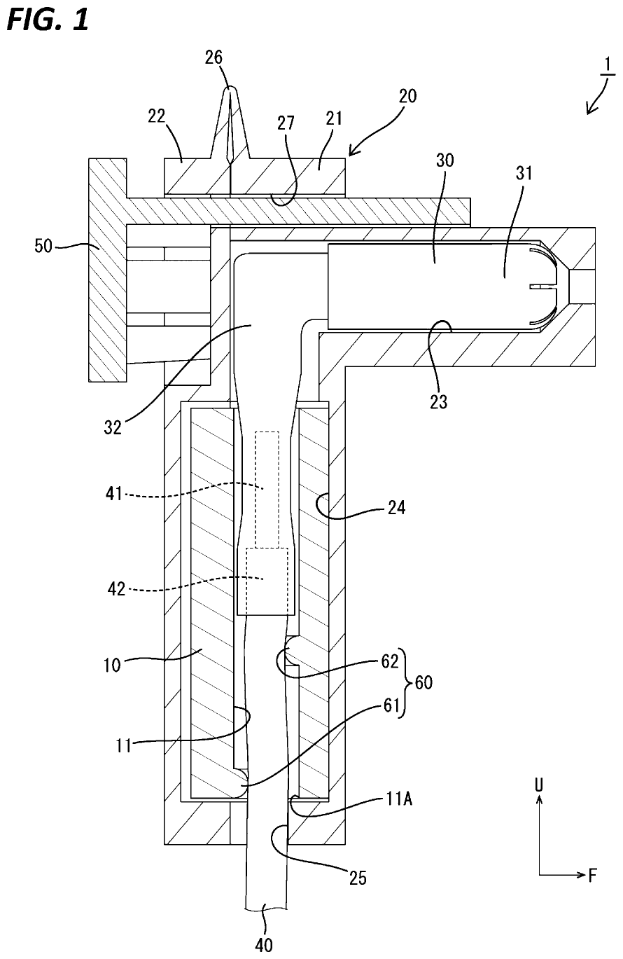

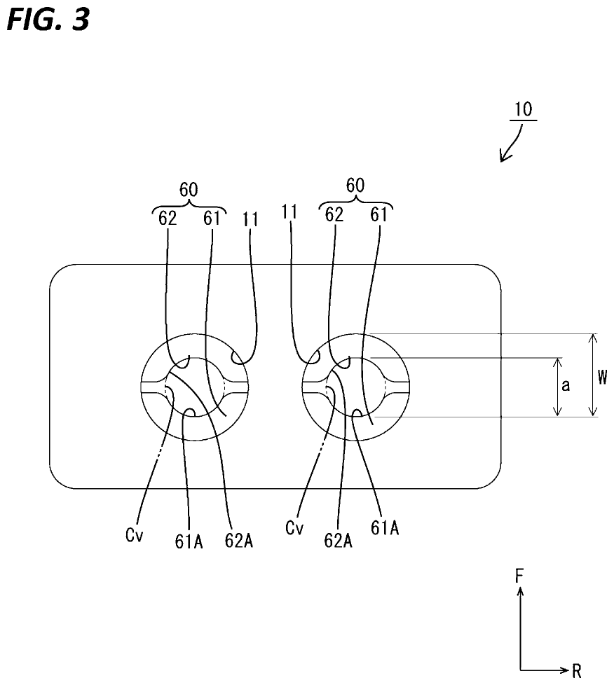

As shown in FIG. 1, a ferrite core 10 according to the embodiment is provided in a connector 1. The connector 1 is a so-called squib connector used to control a seat belt pretensioner, an airbag inflator or the like of a vehicle. The connector 1 includes a housing 20, terminal fittings 30, wires 40 and the like beside the ferrite core 10. Note that, in the following description, a right side of FIG. 1 and an upper side of FIG. 3 are referred to as a front side concerning a front-rear direction. A vertical direction is based on a vertical direction of each figure except FIG. 3. The vertical direction is synonymous with a length direction of through holes 11 to be described later and is an inserting direction of the wires 40. A lateral direction is synonymous with a width direction and based on a lateral direction of FIG. 3. In figures, F indicates the front side, U indicate an upper side and R indicates a right side. The housing 20 is connectable to an unillustrated mating housing from front.

<Housing>

The housing 20 is made of synthetic resin and includes, as shown in FIG. 1, a housing body 21 and a lid portion 22. The housing body 21 has an inverted L shape extending forward and downward from an upper end in a side view viewed from the lateral direction. The housing body 21 includes first cavities 23 for accommodating the terminal fittings 30 and a second cavity 24 for accommodating the ferrite core 10. The first cavity 23 is formed into an inverted L shape in conformity with the shape of the inverted L-shaped housing body 21. Specifically, the first cavity 23 penetrates in the front-rear direction in an upper end part of the housing body 21. The rear end of the first cavity 23 is open rearward and extends downward like a groove. A plurality of the first cavities 23 are formed and arranged side by side in the lateral direction. The second cavity 24 has a rectangular parallelepiped shape and open rearward in a lower end of the housing body 21. The upper end of the second cavity 24 communicates with the lower ends of the plurality of first cavities 23. The second cavity 24 communicates with an outside space via a groove 25, through which the wires 40 are passed and which has a semicircular cross-section, in a lower end.

As shown in FIG. 1, the lid portion 22 covers the rear end of the housing body 21. In this way, the lid portion 22 closes rear end openings of the first cavities 23 and the second cavity 24. The upper end of the lid portion 22 is openably and closably coupled to the upper end of the housing body 21 via a hinge 26. The lid portion 22 is locked to left and right side parts of the housing body 21 by unillustrated locking portions provided on left and right side parts of the lid portion 22. The housing 20 forms an insertion hole 27, through which a detecting member 50 is insertable, with the rear end of the housing 21 closed by the lid portion 22. The detecting member 50 inserted through the insertion hole 27 is movable to a standby position (see FIG. 1) and a detection position with respect to the housing 20. In particular, the detecting member 50 is movable from the standby position to the detection position with the housing 20 properly connected to the unillustrated mating housing. It can be detected that the housing 20 and the mating housing are properly connected when the detecting member 50 is movable to the detection position.

<Terminal Fittings>

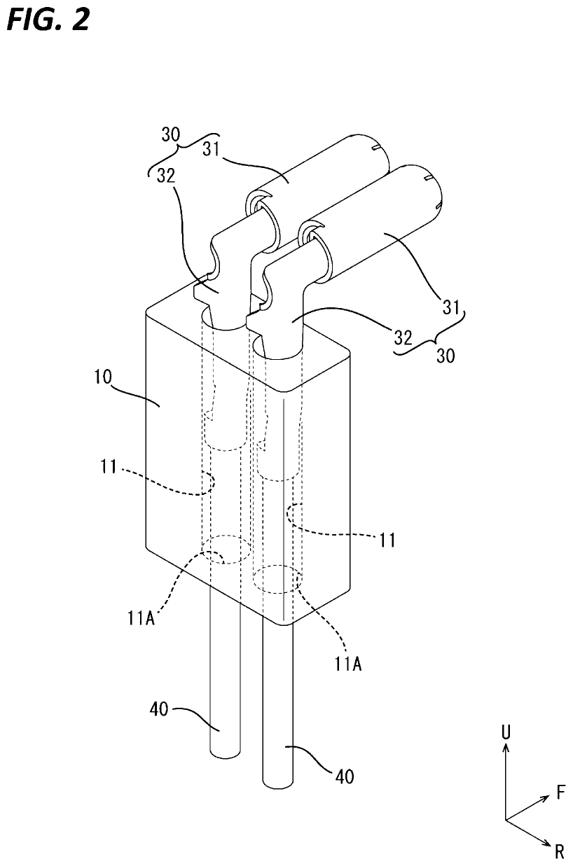

The terminal fitting 30 is a female terminal fitting and formed by bending a conductive metal plate. A plurality of (two in FIG. 2) the terminal fittings 30 are provided to correspond to the plurality of first cavities 23. As shown in FIGS. 1 and 2, the terminal fitting 30 includes a body portion 31 extending in the front-rear direction and a barrel portion 32 extending downward from the rear end of the body portion 31 and crimped into connection with the wire 40. The terminal fitting 30 is inserted into the first cavity 23 from behind the housing body 21 with the rear end of the housing body 21 opened by the lid portion 22.

<Wires>

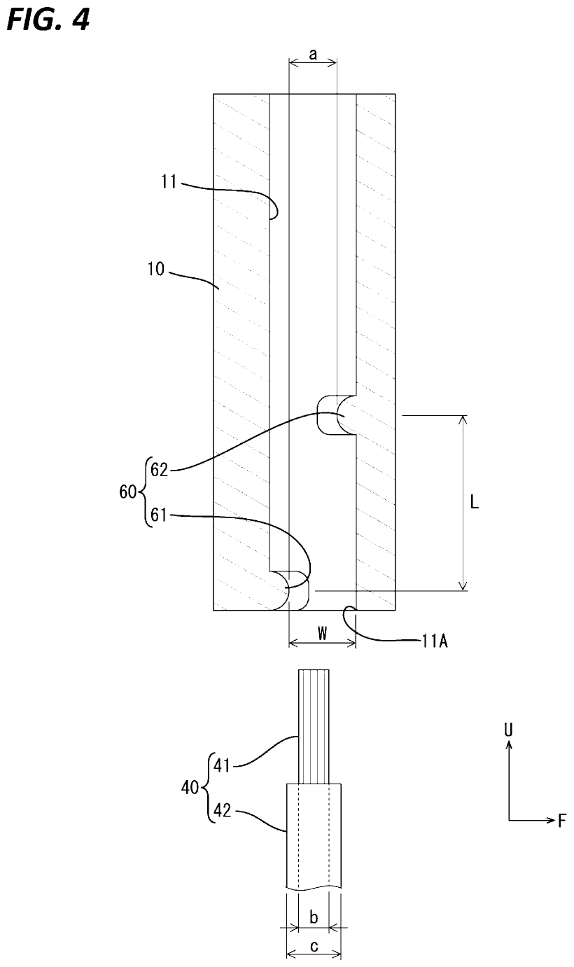

As shown in FIG. 1, the wire 40 is a coated wire and includes a core 41 and a coating 42 surrounding the outer periphery of the core 41. The core 41 is formed by twisting a multitude of strands made of conductive metal. The coating 42 is made of insulating resin. As shown in FIG. 4, the coating 42 is removed in a tip part of the wire 40 to expose the core 41. The barrel portion 32 of the terminal fitting 30 is crimped to the wire 40 after the wire 40 is inserted into the ferrite core 10.

<Ferrite Core 10>

The ferrite core 10 is formed by sintering a metal oxide and has properties as a magnetic body. As shown in FIGS. 1 to 3, the ferrite core 10 is integrally formed into a rectangular parallelepiped shape. The ferrite core 10 is formed with the through holes 11. The through holes 11 have a circular cross-section and penetrate through the ferrite core 10 in the vertical direction. The wires 40 are arranged inside the through holes 11. A plurality of (two in FIG. 3) the through holes 11 are formed side by side in the lateral direction, and the wires 40 are arranged in the respective through holes 11. As shown in FIG. 1, the through hole 11 is formed at a position offset forward from a center in the front-rear direction. In this way, a center of gravity of the ferrite core 10 is located behind the center in the front-rear direction.

<Holding Portion>

The ferrite core 10 includes holding portions 60. The holding portions 60 are provided to hold the wires 40 inserted into the through holes 11. In the case of this embodiment, the holding portion 60 includes a plurality of (two in FIG. 1) projections 61, 62 in each of the through holes 11. The respective projections 61, 62 are made of sintered metal oxide integrated with the ferrite core 10. The respective projections 61, 62 are provided to project from the inner peripheral surface of the through hole 11. As shown in FIG. 3, the respective projections 61, 62 are formed into a semicircular arc shape along the inner peripheral surface of the through hole 11. As shown in FIG. 4, each projection 61, 62 has a semicircular shape in a side view in section. The plurality of projections 61, 62 are formed at an interval in the vertical direction (length direction of the through hole 11). As shown in FIG. 3, the plurality of projections 61, 62 are arranged at positions different in a circumferential direction of the through hole 11. Out of the plurality of projections 61, 62, one projection 61 is provided in one opening 11A, which is an opening of the through hole 11, and the other projection 62 is provided at a position near a center in the length direction of the through hole 11. The plurality of projections 61, 62 have the same shape, arrangement and the like in each through hole 11.

In the case of this embodiment, two projections are provided. As shown in FIG. 4, out of the two projections 61, 62, one projection 61 is provided in the opening 11A on a lower end side of the through hole 11. An opening width W of the opening 11A is larger than an outer diameter of the wire 40. The projection 61 is formed to project from the inner peripheral surface on one circumferential side (rear side) of the through hole 11. The other projection 62 is provided at a position lower then the center in the length direction of the through hole 11. The projection 62 is formed to project from the inner peripheral surface on the other circumferential side (front side) of the through hole 11 at a position different from the projection 61 in the circumferential direction of the through hole 11. An interval L between the two projections 61, 62 in the length direction of the through hole 11 is larger than the outer diameter of the wire 40. As shown in FIG. 3, a virtual circle Cv continuous in the circumferential direction is formed by connecting inner peripheral edges 61A, 62A of the two projections 61, 62 and clearances between both ends of the inner peripheral edges 61A, 62A.

As shown in FIG. 3, an opening diameter of the above virtual circle defined by the inner peripheral edges 61A, 62A of the plurality of projections 61, 62 is a when the through hole 11 is viewed from the lateral direction (from above or below). This opening diameter a is set to satisfy a relational expression of b<a<c when b denotes an outer diameter of the core 41 in the wire 40 and c denotes an outer diameter of the coating 42 (outer diameter of the entire wire 40).

Next, the assembling of the connector 1 is described. In assembling, the wires 40 are first inserted into the through holes 11 of the ferrite core 10. As shown in FIG. 4, the wire 40 is inserted into the through hole 11 through the opening 11A from a state where the core 41 exposed in the tip part is facing the opening 11A (entrance) on the lower end side of the through hole 11. The projection 61 is provided in the opening 11A. The projection 61 is provided at the entrance of the through hole 11 and can be visually confirmed from outside. Thus, the wire 40 can be inserted through the opening 11A without interfering with the projection 61. Further, since the opening width W of the opening 11A is larger than the outer diameter of the wire 40, the wire 40 can be easily inserted.

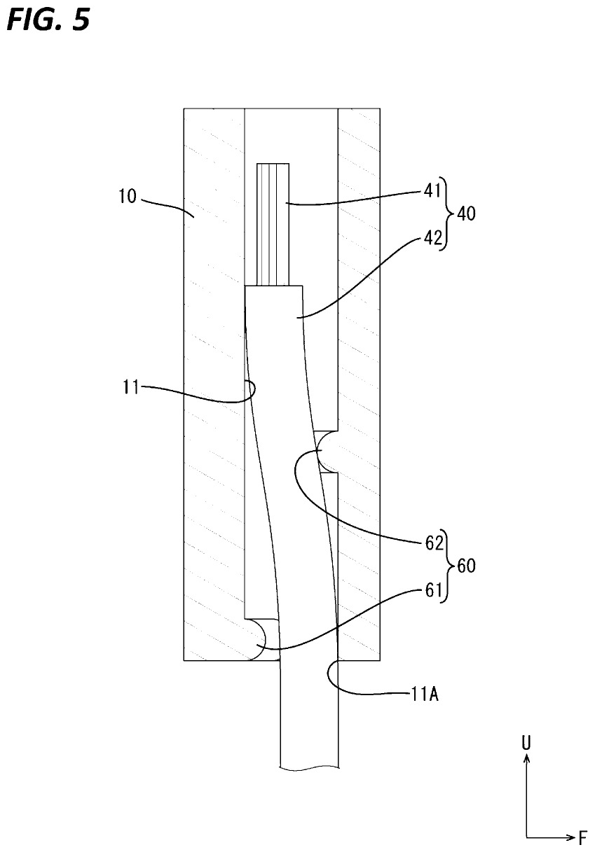

The wire 40 is further pushed into the through hole 11 and passed through the projection 62 in the through hole 11. The projection 62 is provided at the interval L from the projection 61 in the length direction of the through hole 11. The interval L is set larger than the outer diameter of the wire 40. Thus, the wire 40 can be effortlessly passed. Further, the projection 62 is arranged at the position different from the projection 61 in the circumferential direction of the through hole 11. Thus, in passing through the projection 62, the tip part of the wire 40 inserted to be closer to the inner peripheral surface on the front side in the through hole 11 by avoiding the projection 61 may be inclined and pushed along the inner peripheral surface on the rear side in the through hole 11 as shown in FIG. 5.

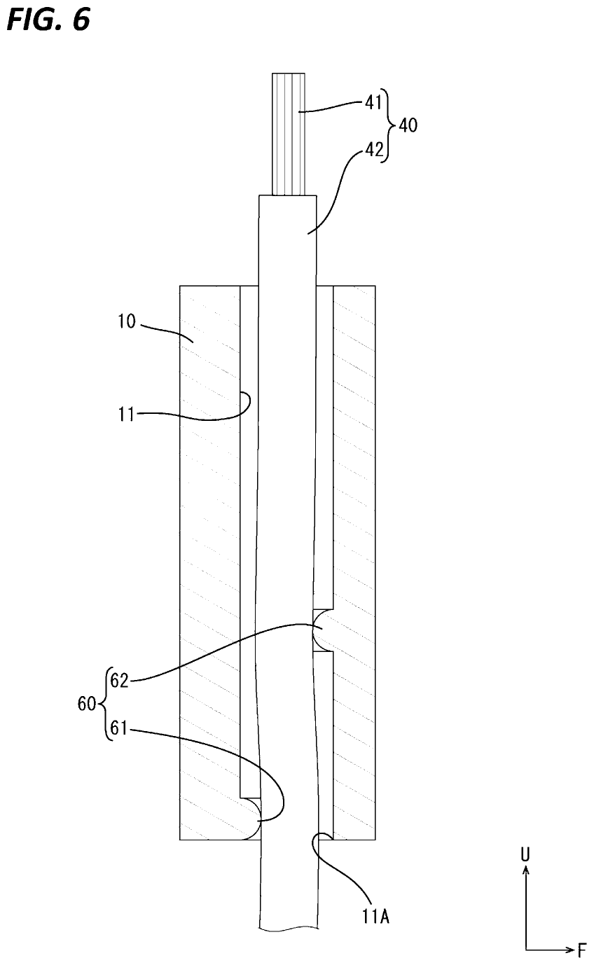

The wire 40 is further pushed and inserted into the through hole 11. As shown in FIG. 6, the wire 40 inserted into the through hole 11 is held in a bent state by the holding portion 60. The wire 40 is held with a suitable holding force by having the easily resiliently deformable coating 42 made of resin pressed by the plurality of projections 61, 62 provided to have the opening diameter a larger than the outer diameter b of the core 41 and smaller than the outer diameter c of the wire 40. In this way, the ferrite core 10 can be positioned at a desired position with respect to the wire 40. Further, since the center of gravity of the wire 40 is located at a rear position, such a force as to tilt an upper end side rearward acts on the ferrite core 10 positioned with respect to the wire 40. Since this force acts in a direction to further push the two projections 61, 62 against the wire 40, the wire 40 can be more satisfactorily held.

Thereafter, the barrel portion 32 of the terminal fitting 30 is crimped to the core 41 exposed in the tip part of the wire 40 and the coating 42. A lower end side of the barrel portion 32 is inserted into an upper part of the through hole 11 (see FIG. 2) to adjust the relative position of the ferrite core 10 with respect to the wire 40. Then, the body portion 31 of the terminal fitting 30 is inserted into the first cavity 23 from behind the housing body 21. Further, the ferrite core 10 is accommodated into the second cavity 24 from behind the housing body 21. In this state, the rear end of the housing body 21 is covered by the lid portion 22 to close the respective rear openings of the first cavities 23 and the second cavity 24. Finally, the detecting member 50 is assembled with the housing 20. The detecting member 50 is assembled by being inserted to the standby position into the insertion hole 27 from behind the housing 20. The connector 1 is assembled in this way.

Before the start of the assembling operation of the terminal fittings 30 and the ferrite core 10 with the housing 20 or during the assembling operation, the ferrite core 10 is held in such a state that a position shift with respect to the wires 40 is restricted by the holding portions 60. Thus, a worker can smoothly perform the above assembling operation.

As described above, according to this embodiment, the ferrite core 10 includes the holding portions 60 capable of holding the wires 40 in the through holes 11 in which the wires 40 are arranged. Thus, a relative movement of the ferrite core 10 with respect to the wires 40 can be restricted and the ferrite core 10 can be positioned with respect to the wires 40. For example, if holding portions are not provided in through holes, a ferrite core having wires inserted thereinto slips down along the wires unless the ferrite core is held by the hand of a worker or the like. However, by providing the holding portions 60, the ferrite core 10 is positioned with respect to the wires 40 without being pressed by a hand or the like. Thus, the assembling workability of the connector 1 can be improved.

Further, the holding portion 60 includes the plurality of projections 61, 62 projecting from the inner peripheral surface of the through hole 11 of the ferrite core 10. The plurality of projections 61, 62 are arranged at the interval L in the length direction of the through hole 11 and at the positions different in the circumferential direction of the through hole 11. Thus, the holding portion can be realized by a simple configuration. The holding portion 60 is configured by integrally forming the plurality of projections 61, 62 to the ferrite core 10. Thus, an increase in the number of components can be suppressed.

Further, the wire 40 is such a coated wire that the core 41 is covered around by the coating 42, the core 51 is exposed in the tip part, and the relational expression of b<a<c is satisfied when a denotes the opening diameter of the virtual circle Cv defined by the inner peripheral edges 61A, 62A of the projections 61, 62 when the through hole 11 is viewed from the length direction, b denotes the outer diameter of the core 41 of the wire 40 and c denotes the outer diameter of the coating 42 covering the core 41. Thus, in inserting the tip part of the wire 40 into the through hole 11, the interference of the core 41 exposed in the tip part of the wire 40 with the projections 61, 62 can be avoided or mitigated. Thus, a proper holding force can act between the projections 61, 62 and the coating 42. As a result, the wire 40 can be smoothly inserted and, moreover, the wire 40 can be satisfactorily held by the projections 61, 62.

Further, out of the plurality of projections 61, 62, the projection 61 is provided in the opening 11A, which is an opening of the through hole 11. Thus, the worker easily visually confirms the projection 61, wherefore the wire 40 can be easily inserted through the opening 11A while avoiding the projection 61.

Further, the holding portion 60 is entirely provided in the through hole 11. Thus, the holding portion 60 is less likely to interfere with external matters and the damage of the holding portion 60 can be prevented.

### Other Embodiments of Present Disclosure

The embodiment disclosed this time should be considered illustrative in all aspects, rather than restrictive.

For example, although the holding portion is configured to include the plurality of projections in the case of the above embodiment, the configuration of the holding portion is not particularly limited as long as the holding portion is provided in the through hole and holds the inserted wire.

Although the holding portion includes two projections in the case of the above embodiment, the holding portion may include three or more projections as another embodiment.

Although the projection is formed to have a semicircular arc shape along the inner peripheral surface of the through hole in the case of the above embodiment, the projection may be formed to have an arc shape shorter than a semicircular arc in the circumferential direction such as a quarter circular arc shape.

Although the projection is formed to have a semicircular cross-section in the case of the above embodiment, the cross-sectional shape of the projection may be a polygonal shape such as a rectangular, trapezoidal or triangular shape. In these cases, corner parts are preferably rounded.

Although the ferrite core is provided in the squib connector in the case of the above embodiment, the ferrite core according to the present disclosure can be provided in components incorporating a ferrite core in general.

Although the holding portion is integrally provided to the ferrite core in the case of the above embodiment, the holding portion may be separate from the ferrite core and may be configured to hold the wires by being inserted into the through holes of the ferrite core.

Although the ferrite core is integrally provided in the case of the above embodiment, the ferrite core may be composed of a pair of unitable half bodies.

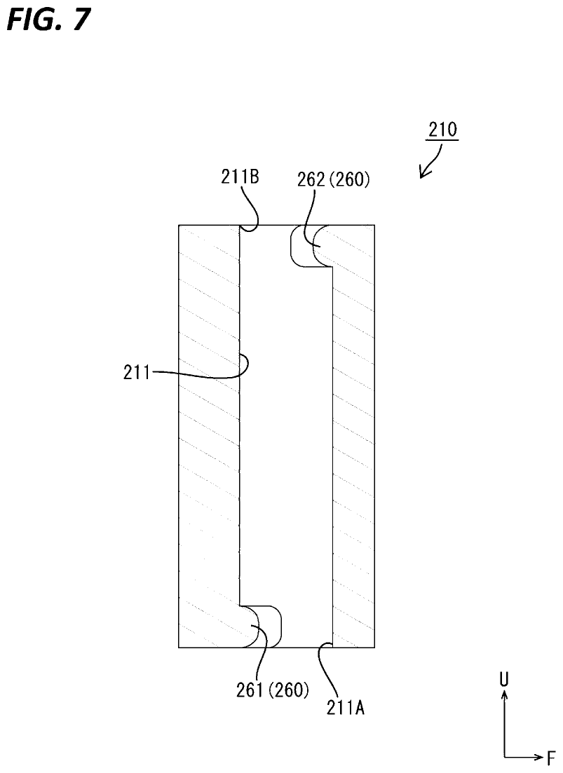

Although one of the plurality of projections is provided in the opening of the through hole in the case of the above embodiment, this is not essential. For example, any of the plurality of projections may be provided at a position retracted from the opening of the through hole. Further, a plurality of projections may be provided in both openings of a through hole. FIG. 7 illustrates such a case. In the case of FIG. 7, a holding portion 260 includes projections 261, 262 as the plurality of projections. The projections 261, 262 are respectively provided in openings 211A, 211B on both upper and lower ends of a through hole 211 formed in a ferrite core 210. In this case, since the projection 261, 262 can be visually confirmed from outside on the side of either one of the openings on both ends, a wire can be easily inserted. Further, vertical directionality in the ferrite core 210 can be eliminated and assembling workability with a connector and the like can be further improved.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A ferrite core, comprising:
a through hole, a wire being arranged in the through hole; and
a holding portion provided to hold the wire in the through hole.

2. The ferrite core of claim 1, wherein:
the holding portion includes a plurality of projections projecting from an inner peripheral surface of the through hole, and
the plurality of projections are arranged at an interval in a length direction of the through hole and at positions different in a circumferential direction of the through hole.

3. The ferrite core of claim 2, wherein:
the wire is such a coated wire that a core is surrounded around by a coating, and the core is exposed in a tip part, and
a relational expression of b<a<c is satisfied when a denotes an opening diameter of a virtual circle defined by inner peripheral edges of the plurality of projections when the through hole is viewed from the length direction, b denotes an outer diameter of the core and c denotes an outer diameter of the coating.

4. The ferrite core of claim 2, wherein at least one of the plurality of projections is provided in an opening of the through hole.

5. The ferrite core of claim 1, wherein the holding portion is entirely provided in the through hole.
